(19) United States
(12) Patent Application Publication
(10) Pub. No.: US 2010/0209615 A1
(43) Pub. Date: Aug. 19, 2010

(54) Method and System for Applying Hot Melt Adhesive Powder onto a Non-Metallic Surface

(76) Inventors: Jakov Makover, Maccabim (IL); Yaacov Sadeh, Rechovot (IL); Bar Cochva Madrix, Tel Avlv (IL)

Correspondence Address: Dr. BANGER SHIA;Patent Office of Bang Shia, 102 Lindencrest Ct., Sugar Land, TX, 77479-5201, US

(21) Appl. No.: 12/530,655

(22) PCT Filed: Feb. 2, 2008
(86) PCT No.: PCT/CN2008/000274

§ 371 Date: Mar. 19, 2010

(30) Foreign Application Priority Data
Mar. 23, 2007 (CN) 200710089762.3

(51) Int. Cl. B05D 1/06; B05B 5/025

(52) U.S. Cl. 427/475; 118/621

(57) ABSTRACT

A method and a system for applying hot melt adhesive powder onto a non-metallic surface are disclosed. The hot melt adhesive powder is sprayed out from a spray head while being charged with electrostatic charges, and then the charged hot melt adhesive powder will be attached to the whole surface of a non-metallic component by electrostatic force, or only attached to a desired area of the non-metallic component by pre-coating the desired area with conductive liquid. By spraying the hot melt adhesive in the form of powder, there is no need to heat the adhesive in advance. When the surface of the non-metallic component is 3-dimensional, the charged adhesive powder can be introduced onto the surface of the to-be-bonded component and attached to the desired surface without the omni-directional spraying operation. Excessive powder will be easily blown or brushed away and will be recycled.

### BACKGROUND OF THE INVENTION

1. Field of the Invention

The present invention relates to a method and a system for applying hot melt adhesive powder onto a surface, and more particularly to a method and a system for applying hot melt adhesive powder onto a non-metallic surface.

2. Description of the Prior Art

A traditional method for applying hot melt adhesive powder onto a geometric surface comprises the steps of heating the hot melt adhesive powder to a proper temperature to melt it into liquid state first, and then spraying or brushing the liquid adhesive onto the surface of the component by a spraying gun or a brush. This traditional method suffers from the following drawbacks:

1. Since the adhesive powder has to be heated to a high temperature above 200 degrees centigrade, it requires using an expensive heating system to keep heating the melting furnace and the distal end of the spraying gun.

2. It is very difficult to control the direction and uniformity of spraying, especially when the surface to be sprayed is 3-dimensional. Therefore, in order to perpendicularly apply the hot melt adhesive powder onto the surface of the component, the spraying operation has to be omni-directional according to the surface shape.

3. The excessive hot melt adhesive unexpectedly sprayed onto an undesired area is difficult to be removed, so it not only takes time and effort to clean it off but also causes material waste.

The present invention has arisen to mitigate and/or obviate the afore-described disadvantages.

### SUMMARY OF THE INVENTION

The primary objective of the present invention is to provide a method and a system for applying hot melt adhesive powder onto a non-metallic surface through which the adhesive powder can be directly and uniformly sprayed onto a to-be-bonded non-metallic surface without pre-heating the hot melt adhesive powder.

In order to achieve the above objective, the method for applying hot melt adhesive powder onto a non-metallic surface in accordance with the present invention comprises the steps of:

charging hot melt adhesive powder with electrostatic charges: the hot melt adhesive powder is pushed from an air pressurized powder chamber into a spray head, and while moving through the spray head, the hot melt adhesive powder is charged with the electrostatic charges;

spraying the charged hot melt adhesive powder: the charged hot melt adhesive powder is sprayed onto a surface of a to-be-bonded non metallic component which is placed on a mesh, and the charged hot melt adhesive powder adheres to the surface of the non metallic component by means of electrostatic force generated by the electrostatic charges on the powder; and

recycling excessive hot melt adhesive powder: the hot melt adhesive powder that doesn't adhere to the surface of the non-metallic component falls down through the mesh and then is sucked back into the air pressurized powder chamber for reuse.

Further, the system for applying hot melt adhesive powder onto a non-metallic surface comprises an air pressurized powder chamber, a pipe, a spray head and a spraying chamber. The pipe has one end connected to the air pressurized powder chamber. The spray head is connected to the other end of the pipe and charges hot melt adhesive powder that moves through therein with electrostatic charges. The spraying chamber is located under the spray head, a non-metallic component is sprayed in the spraying chamber, and a bottom of the spraying chamber is connected to the air pressurized powder chamber in such a manner that excessive hot melt adhesive powder is recycled into the air pressurized powder chamber for reuse.

The method for applying hot melt adhesive powder onto a non-metallic surface of the present invention can further comprises a step of coating a to-be-bonded area on the to-be-bonded surface of the non-metallic component with a conductive liquid before the step of spraying the charged hot melt adhesive powder.

With the method for applying hot melt adhesive powder onto a non-metallic surface of the present invention, the hot melt adhesive is directly sprayed in the form of powder without heating the adhesive in advance, thus reducing the production cost. Further, when the surface of the non-metallic component is 3-dimensional, the charged adhesive powder can be introduced onto the surface of the to-be-bonded component and attached to the desired surface without the omni-directional spraying operation. Powder will accumulate only in the area where the conductive liquid is coated. Excessive powder will be easily blown and brushed away and will be recycled without causing the waste of the adhesive powder, thus saving the production cost.

### BRIEF DESCRIPTION OF THE DRAWINGS

FIG. 1 is a structural view showing a system for applying hot melt adhesive powder onto a non-metallic surface in accordance with a first embodiment of the present invention;

FIG. 2 is a perspective view showing that a spraying manifold is a cone-shaped opening in accordance with the present invention;

FIG. 3 is a perspective view showing that a spraying manifold is split into multiple nozzles; and

FIG. 4 is a structural view showing a system for applying hot melt adhesive powder onto a non-metallic surface in accordance with a second embodiment of the present invention;

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

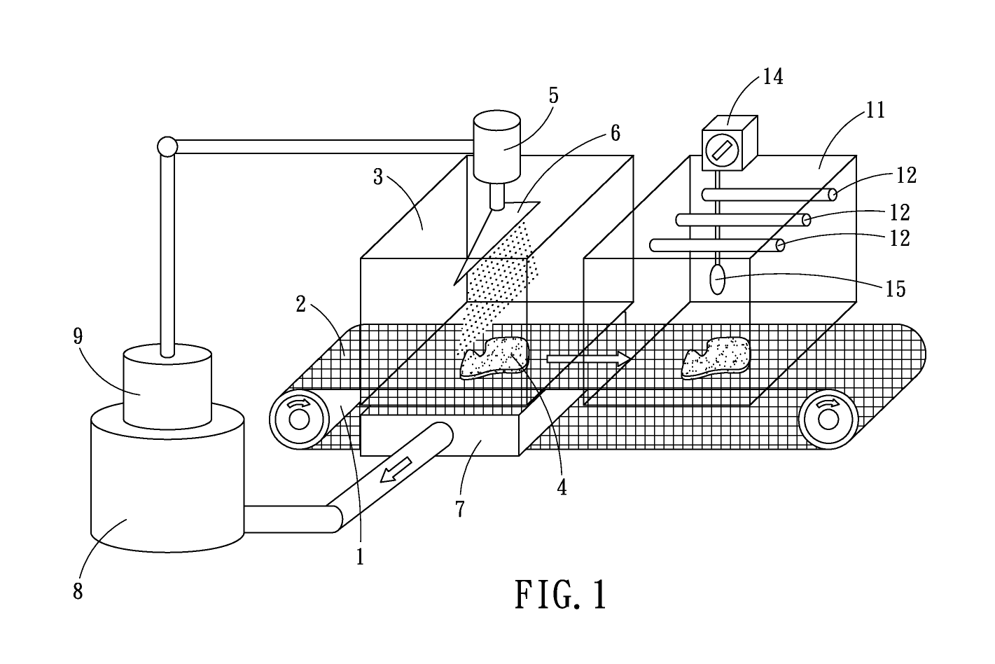

Referring to FIG. 1, a system and a method for applying hot melt adhesive powder onto a non-metallic surface in accordance with a first embodiment of the present invention are disclosed, and the method for applying hot melt adhesive powder onto a non-metallic surface in accordance with the first embodiment of the present invention comprises the steps of:

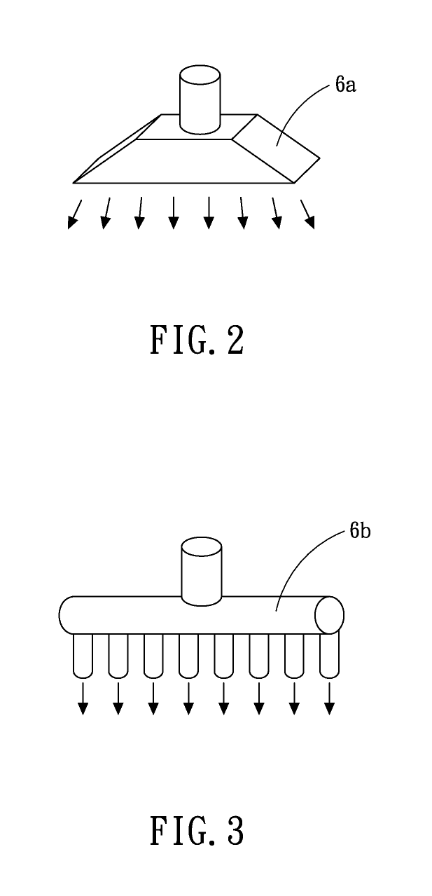

1. Charging hot melt adhesive powder with electrostatic charges: a spray head 5 is connected to an air pressurized powder chamber 8 containing the adhesive powder. The chamber 8 is pressurized under high air pressure by an air pump 9. The adhesive powder is stored in the air pressure powder chamber 8 and pushed out from the chamber 8 into the spray head 5. The spray head 5 is specially designed to charge the powder pushed out from the air pressure chamber 8 with electrostatic charges. Such a method is commonly known in the trade as Tribo-chager or Corona charge. The spray head 5 can be produced by many companies such as Nordson USA. A spraying manifold 6 is attached to the spray head 5. The spraying manifold 6 can be a cone-shaped opening 6a as shown in FIG. 2 or split into multiple nozzles 6b as shown in FIG. 3.

2. Spraying the charged hot melt adhesive powder: a to-be-bonded surface of a non-metallic component 4 is placed under the spray head 5, and the non-metallic component 4 is placed on a mesh belt 2 and moved into the spraying chamber 3 by a conveyor 1. The spraying chamber 3 will be closed by the moving doors at the entry and exit thereof along the belt as soon as the component 4 enters the chamber 3. In the present invention, the chamber 3 is closed in order to prevent the adhesive powder from escaping from it. The sprayed powder adheres to the to-be-bonded surface of the non-metallic component 4 by the electrostatic charges.

3. Recycling excessive powder: the excessive powder that does not attach to the to-be-bonded surface of the component 4 is sucked down onto the lower part 7 of the spraying chamber 3 through the mesh belt 2 by the pump 9. The excessive powder is finally accumulated into the air pressurized powder chamber 8 where the excessive powder can be reused by the spray head 5.

4. Melting the adhesive powder: the non-metallic component 4 which has been sprayed with the adhesive powder is moved into a heating chamber 11, and then the heating chamber 11 will heat the adhesive powder by means of direct radiation of infrared light, hot air flow, or microwave heating, all of which are commonly known methods of heating materials. In the present embodiment, the heating chamber 11 is installed with halogen lamps 12 at an upper side thereof to radiate heat energy down onto the non-metallic component 4, and the heating temperature is controlled by a temperature controller 14 and a temperature sensor 15.

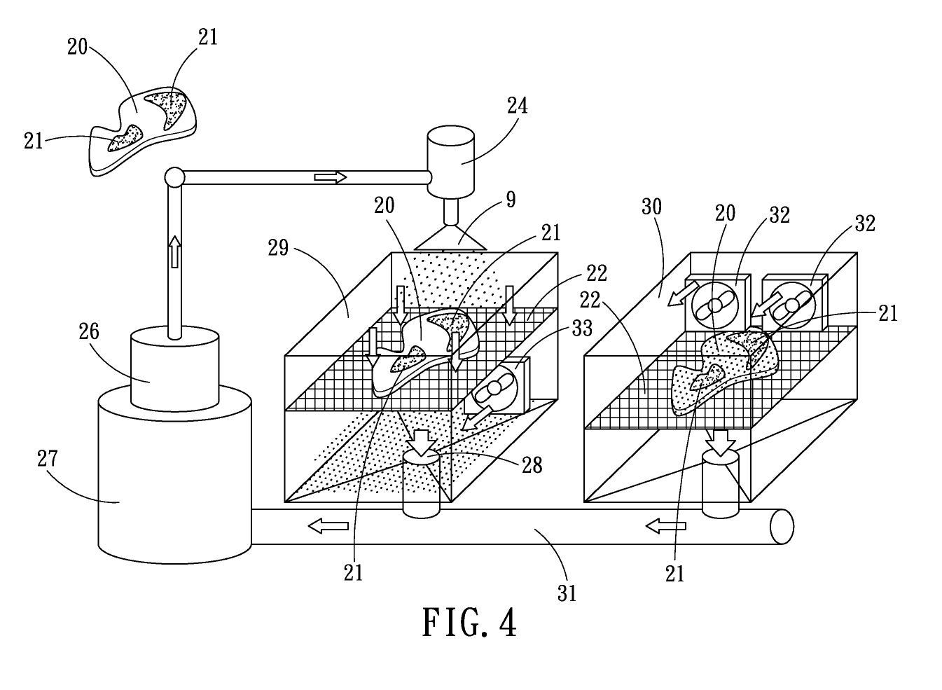

Referring to FIG. 4, a method for applying hot melt adhesive powder onto a non-metallic surface in accordance with a first embodiment of the present invention comprises the steps of:

1. Charging adhesive powder with electrostatic charges: this step is the same as the step of charging adhesive powder with electrostatic charges in the first embodiment;

2. Spraying the charged hot melt adhesive powder: a to-be-bonded area 21 of a to-be-bonded non-metallic component 20 is first coated with a conductive liquid, such as the 1P More-prep sold by Rohm and Haas of the USA, and the to-be-bonded component 20 is then placed on the mesh 22 inside the spaying chamber 20. The spraying manifold 6 of the spray head 5 will spay the charged hot melt adhesive powder onto the whole surface of the non-metallic component 20, and then the charged hot melt adhesive powder will be adhered to the area 21 on the surface much stronger than other areas on the surface.

3. Recycling excessive hot melt adhesive powder: the excessive hot melt adhesive powder that doesn't reach the surface of the non-metallic component 20 will fall down to the bottom of the spraying chamber 29 where it is steered by an air fan 33 and then recycled into a bottom of a collection chamber 28 and further through a pipe 31 into an air pressurized powder chamber 8 by a pump 9.

In the present embodiment, the non-metallic component 20 which has been sprayed with the hot melt adhesive powder is moved into the air flow chamber 30 manually but not by the conveyor in the first embodiment. Two air fans 32 are fixed in the air flow chamber 30, so that the air flow can be directed onto the surface of the non-metallic component 20. The air flow caused by the air fans 32 will blow down the powder located on the areas other than the area 21, and the hot melt adhesive powder which is blown down will be sucked into the air pressurized powder chamber 8 by the pump 9. The flow rate of the air fans 32 can be adjusted by controlling the RPM of the air fans 32 using a common RPM controller.

4. Melting the adhesive powder: the non-metallic component 20 is taken out of the air flow chamber 30 with only the area 21 coated with the hot melt adhesive powder and then delivered into the heating chamber 11 as shown in FIG. 1 to continue the melting process as described in the first embodiment.

While we have shown and described various embodiments in accordance with the present invention, it is clear to those skilled in the art that further embodiments may be made without departing from the scope of the present invention.

What is claimed is:

1. A method for applying hot melt adhesive powder onto a non-metallic surface comprising the steps of:
charging hot melt adhesive powder with electrostatic charges: the hot melt adhesive powder is pushed out of an air pressurized powder chamber by air pressure and into a spray head, and while moving through the spray head, the hot melt adhesive powder is charged with the electrostatic charges;
spraying the charged hot melt adhesive powder: the charged hot melt adhesive powder is sprayed onto a to-be-bonded surface of a non metallic component which is placed on a mesh, and the charged hot melt adhesive powder adheres to the to-be-bonded surface of the non metallic component by electrostatic force generated by the electrostatic charges on the hot melt adhesive powder; and
recycling excessive hot melt adhesive powder: the hot melt adhesive powder that doesn't adhere to the to-be-bonded surface of the non-metallic component falls down through the mesh and then is sucked back into the air pressurized powder chamber for reuse.

2. The method for applying hot melt adhesive powder onto a non-metallic surface as claimed in claim 1 further comprising a step of coating a to-be-bonded area on the to-be-bonded surface of the non-metallic component with a conductive liquid before the step of spraying the charged hot melt adhesive powder.

3. A system for applying hot melt adhesive powder onto a non-metallic surface comprising:
an air pressurized powder chamber;
a pipe having one end connected to the air pressurized powder chamber
a spray head being connected to the other end of the pipe, the spray head charging hot melt adhesive powder that moves through therein with electrostatic charges; and
a spraying chamber being located under the spray head, a non-metallic component being sprayed in the spraying chamber, a bottom of the spraying chamber being connected to the air pressurized powder chamber in such a manner that excessive hot melt adhesive powder is recycled into the air pressurized powder chamber for reuse.

4. The system for applying hot melt adhesive powder onto a non-metallic surface as claimed in claim 3, characterized in that:
the non-metallic component is placed on a moving mesh belt of a conveyor, the spraying chamber is provided with doors that open to let the non-metallic component move into and out of the spraying chamber and close during powder spraying.

5. The system for applying hot melt adhesive powder onto a non-metallic surface as claimed in claim 3 or 4 further comprising a heating chamber, characterized in that, the non-metallic component coated with the hot melt adhesive powder is delivered manually or by a conveyor into the heating chamber and heated to a predetermined temperature at which the hot melt adhesive powder melts down.

6. The system for applying hot melt adhesive powder onto a non-metallic surface as claimed in claim 5, characterized in that: the heating chamber further includes a temperature controller for setting a required temperature in the heating chamber.
